(19) United States
(12) Patent Application Publication
(10) Pub. No.: US 2018/0331555 A1
(43) Pub. Date: Nov. 15, 2018

(54) Systems and Methods for Operation of a Battery Stack

(71) Applicant: David Meisel, Troy, MI (US)

(72) Inventor: David Meisel, Troy, MI (US)

(21) Appl. No.: 15/591,830

(22) Filed: May 10, 2017

(51) Int. Cl. H02J 7/00; H02P 31/00

(52) U.S. Cl. CPC H02J 7/0081; H02P 31/00; H02J 7/0013; H02J 7/0045

(57) ABSTRACT

Example embodiments include a controller, a first terminal, a second terminal, and a plurality of circuit elements connected in series between the first terminal and the second terminal. Each circuit element of the plurality of circuit elements includes a semiconductive element and a battery. Each circuit element of the plurality of circuit elements also includes a first node connected to the battery, and a second node coupled to the semiconductive element. At least one of the first node or the second node is coupled to another circuit element of the plurality of circuit elements. The system also includes a ground node exclusively coupled to a respective output node of one semiconductive element associated with a particular circuit element of the plurality of circuit elements.

### BACKGROUND

Unless otherwise indicated herein, the materials described in this section are not prior art to the claims in this application and are not admitted to be prior art by inclusion in this section.

Battery stacks are used in many applications to transfer stored electrical energy to power sinks, such as motors, computing devices, or other electricity consuming devices. Each battery in a battery stack typically has two terminals used to transmit electrical energy to a power sink. In a battery stack, a negative terminal of a first battery may be directly coupled to a positive terminal of a second battery, a negative terminal of the second battery may be directly coupled to a positive terminal of a third battery, and so on. However, directly connecting batteries in a stack may cause the batteries to lose electrical energy to heat. Further, such direct connections between the batteries may cause some batteries to discharge more quickly than others in the stack.

Accordingly, in other applications the batteries may not be directly connected. For instance, the batteries may be isolated from one another using switches or semiconductive elements, such as transistors. Where batteries in a battery stack are isolated from each other using semiconductive elements, all of the semiconductive elements may be referenced to a ground. Where each semiconductive element is referenced to the same ground, the batteries may not be truly isolated, because each battery may be connected to the ground. As such, batteries separated by semiconductive elements may exhibit the same inefficient or inconsistent qualities associated with directly connected battery stacks.

### SUMMARY

In one example, a system is described that includes a controller, a first terminal, a second terminal, and a plurality of circuit elements connected in series between the first terminal and the second terminal. Each circuit element of the plurality of circuit elements includes a semiconductive element having an input node, a collector node, and an output node. The input node is configured to receive control signals from the controller and, responsive to receiving the control signals, conduct electric current from the collector node to the output node. Each circuit element of the plurality of circuit elements also includes a battery, having a negative terminal and a positive terminal. The negative terminal is connected to the output node of the semiconductive element. Each circuit element of the plurality of circuit elements also includes a first node connected to the positive terminal of the battery, and a second node coupled to the collector node of the semiconductive element. At least one of the first node or the second node is coupled to another circuit element of the plurality of circuit elements. The system also includes a ground node exclusively coupled to a respective output node of one semiconductive element associated with a particular circuit element of the plurality of circuit elements.

In another example, a method is described that includes sending, by a controller, control signals to a plurality of series-connected circuit elements. The plurality of circuit elements include a first circuit element and a second circuit element. The method also includes receiving, at a plurality of input nodes of a plurality of semiconductive elements associated with the plurality of circuit elements, the control signals. The method further includes responsive to receiving the control signals, transferring, by the plurality of semiconductive elements associated with the plurality of circuit elements, electric current to a plurality of batteries associated with the plurality of circuit elements. Transferring the electric current includes responsive to receiving the control signals, conducting current from a collector node of a first semiconductive element associated with the first circuit element to directly reference an output node of the first semiconductive element to a ground coupled between the first semiconductive element and a first battery associated with the first circuit element such that the first semiconductive element transfers electric current to the first battery. Transferring the electric current also includes responsive to receiving the control signals, conducting current from a collector node of a second semiconductive element associated with the second circuit element to indirectly reference an output node of the second semiconductive element to the ground coupled between the first semiconductive element and the first battery such that the second semiconductive element transfers electric current to a second battery associated with the second circuit element.

In another example, a system is described that includes a controller, a first terminal, a second terminal, and a plurality of circuit elements connected in series between the first terminal and the second terminal. The plurality of circuit elements include a first circuit element having a first battery and a first semiconductive element. The first semiconductive element includes an input node, a collector node, and an output node. The input node is configured to receive control signals from the controller and, responsive to receiving the control signals, conduct electric current from the collector node to the output node. The output node shares a bus with a negative end of the first battery. A positive end of the first battery is coupled to the first terminal. The plurality of circuit elements also include a second circuit element having a second battery and a second semiconductive element. The second semiconductive element includes an input node, a collector node, and an output node. The input node is configured to receive control signals from the controller and, responsive to receiving the control signals, conduct electric current from the collector node to the output node. The output node shares a bus with a negative end of the second battery. The collector node is coupled to a positive end of a battery associated with a third circuit element of the plurality of circuit elements. A positive end of the second battery is coupled to the collector node associated with the first circuit element. The system also includes a single ground exclusively coupled between an output node of a semiconductive element associated with a particular circuit element of the plurality of circuit elements and a negative end of a battery associated with the particular circuit element.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a schematic block diagram of a system, according to an example embodiment.

FIG. 2 shows a simplified circuit diagram, according to an example embodiment.

FIG. 3 shows another simplified circuit diagram, according to an example embodiment.

FIG. 4 shows another simplified circuit diagram, according to an example embodiment.

FIG. 5 shows another simplified circuit diagram, according to an example embodiment.

FIG. 6 shows another simplified circuit diagram, according to an example embodiment.

FIG. 7 shows a control signal, according to an example embodiment.

FIG. 8 is a flow chart of a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Example embodiments described herein include circuit elements that can be connected to form battery stacks. Each circuit element may include a battery and a semiconductive element configured to separate the battery from an adjacent battery in the stack. Though the battery stack may include any number of circuit elements, the battery stack may only include one ground that is exclusively coupled to a single circuit element. Because the ground is exclusively coupled to a single circuit element of the plurality, the batteries may be completely isolated from one another. Keeping the batteries isolated in this fashion may allow for less loss to heat and may allow the batteries to discharge more uniformly than systems where each circuit element is coupled to the ground.

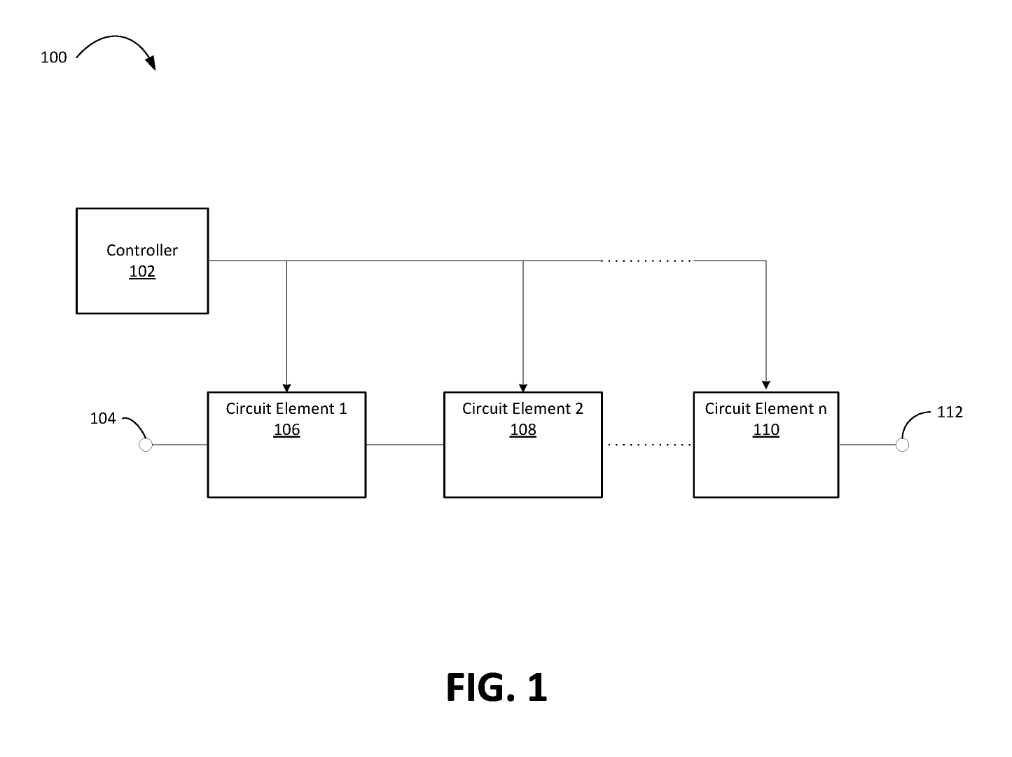

FIG. 1 is a schematic block diagram of a system 100, according to an example embodiment. System 100 includes a controller 102, a first terminal 104, a second terminal 112, and a plurality of circuit elements 106, 108, and 110 connected between terminals 104 and 112. Together, controller 102, terminals 104 and 112, and circuit elements 106, 108, and 110 may form a battery stack.

Controller 102 may include one or more processors and a computer readable medium, such as a non-transitory computer readable medium. The computer readable medium may have instructions stored thereon that, when executed by the processor, cause controller 102 to perform operations as described herein, such as sending control signals to the circuit elements. Controller 102 may additionally, or alternatively, include circuit elements configured to generate control signals and send the control signals to the circuit elements. In some examples, such circuitry may include a transformer, such as a pulse transformer.

In the present example, circuit element 106 is a first circuit element of the plurality of circuit elements, circuit element 108 is a second element of the plurality of circuit elements, and circuit element 110 is an nth circuit element of the plurality of circuit elements. Any number of circuit elements may be connected between circuit element 108 and circuit element 110.

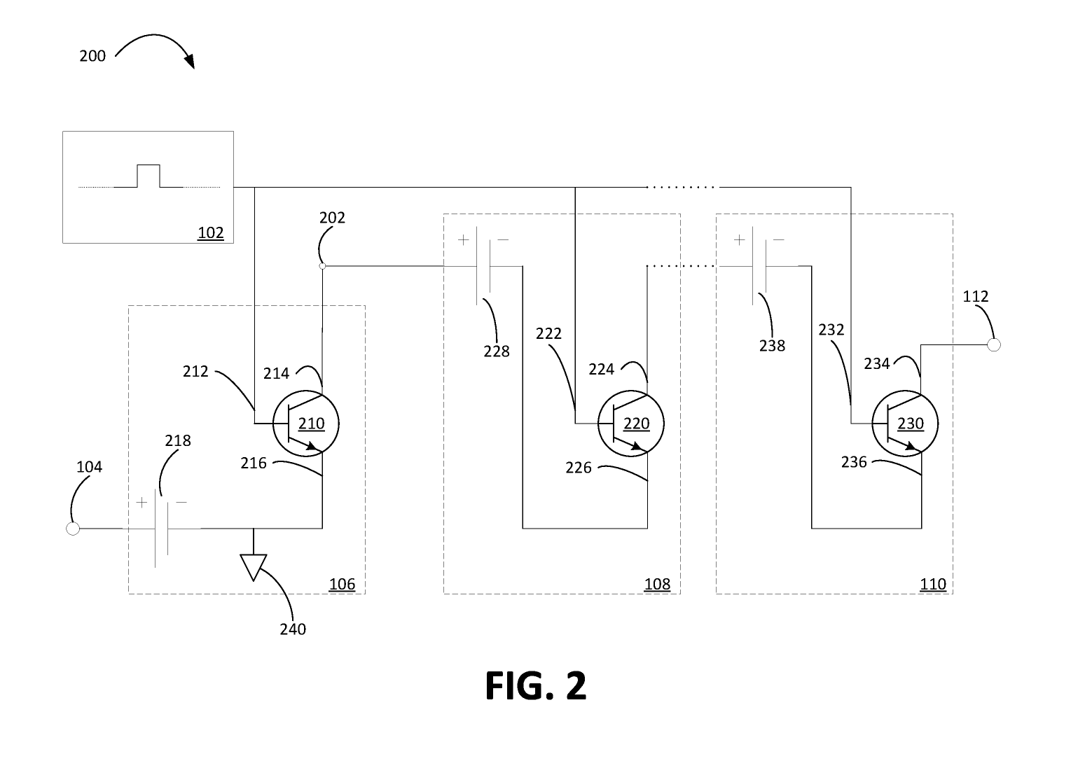

As described below with regard to FIG. 2, each circuit element of the plurality of circuit elements may include a battery and a semiconductive element configured to isolate the battery from an adjacent circuit element of the plurality of circuit elements. For instance, a semiconductive element associated with circuit element 106 may isolate a battery associated with circuit element 106 from circuit element 108. The semiconductive elements may transfer electric current between the circuit elements responsive to receiving control signals from controller 102. Accordingly, control signals from controller 102 may control a current flow between first terminal 104 and second terminal 112.

FIG. 2 shows a simplified circuit diagram of a system 200, according to an example embodiment. System 200 includes example configurations of controller 102, and circuit elements 106, 108, and 110 of the block diagram described above with regard to FIG. 1.

Circuit element 106 includes semiconductive element 210 and battery 218. Semiconductive element 210 includes input node 212, collector node 214, and output node 216. Circuit element 106 also includes a first node associated with terminal 104 and a second node associated with node 202. Circuit element 108 includes semiconductive element 220 and battery 228. Semiconductive element 220 includes input node 222, collector node 224, and output node 226. Circuit element 108 also includes a first node associated with node 202 and a second node. Circuit element 110 includes semiconductive element 230 and battery 238. Semiconductive element 230 includes input node 222, collector node 224, and output node 226. Circuit element 110 also includes a first node and a second node associated with second terminal 112.

The plurality of circuit elements may be connected in series via first nodes and second nodes associated with the circuit elements. For instance, at least one of a first node or second node associated with a circuit element may be coupled to another circuit element of the plurality of circuit elements. In the present example, circuit element 106 and circuit element 108 are connected in series via node 202. That is, the second node associated with circuit element 106 and the first node associated with circuit element 108 are connected. Each such connection between a pair of circuit elements of the plurality of circuit elements may involve a positive end of a battery sharing a bus with a collector node. In the present example, the positive terminal of battery 228 associated with circuit element 108 shares a bus with collector node 214 associated with circuit element 106.

Of the plurality of circuit elements, a first circuit element, such as circuit element 106, may only be connected to another circuit element of the plurality of circuit elements via a second node associated with the first circuit element. A second circuit element, such as circuit element 108, may be connected to other circuit elements via a first and second node associated with the second circuit element. An nth circuit element, such as circuit element 110, may only be connected to another circuit element via a first node associated with the nth circuit element.

Each semiconductive element may share a single control signal bus coupled to controller 102, such that, responsive to receiving the control signals, each semiconductive element simultaneously transfers electric current towards first terminal 104. In this way, each battery of the plurality may be discharged by substantially the same amount. In some embodiments, each battery of the plurality of circuit elements may discharge by an amount within 0.1 Volts of one another. For example, battery 218 may discharge by 5.1 Volts, battery 228 may discharge by 5.05 Volts, and battery 238 may discharge by 5.08 Volts.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Subsequent to discharging the batteries, the batteries may be charged. The controller may receive a direct current signal and output a signal to the input nodes based on the received signal. The controller may send control signals that permit the batteries to recharge based on the received direct current signal.

System 200 additionally includes a ground 240 exclusively coupled to output node 216 and a negative terminal of battery 218 associated with circuit element 106. Input node 212 may be configured to receive control signals from controller 102 and, responsive to receiving the control signals, conduct electric current from collector node 214 to output node 216. Because output node 216 is coupled with ground 240, conducting the electric current from collector node 214 to output node 216 may directly reference collector node 214 to ground 240. Further, because the positive terminal of battery 228 associated with circuit element 108 shares a bus with collector node 214, battery 228 may be directly referenced to ground 240 and thereby discharged to drive the electric current. In this fashion, control signals from controller 102 may control semiconductive element 210.

In the present example, ground 240 is not coupled to circuit elements 108 or 110. Responsive to receiving control signals from controller 102, input node 222 may conduct electric current between collector node 224 and output node 226 and input node 232 may conduct electric current between collector node 234 and output node 236 in much the same way described above with regard to circuit element 106. However, rather than directly referencing collector nodes 224 and 234 to ground 240, semiconductive elements 220 and 230 are configured to indirectly reference collector nodes 224 and 234 to ground 240 responsive to receiving the control signals from controller 102.

Though, in the present example, ground 240 is coupled between a negative terminal of battery 218 and output node 216 associated with circuit element 106, ground 240 may be exclusively coupled between a negative terminal of a battery and an output node associated with any particular circuit element of the plurality of circuit elements. For example, in some embodiments, ground 240 may be coupled to circuit element 108, circuit element 110 or any circuit element coupled between circuit elements 108 and 110. In still other embodiments, ground 240 may be coupled to two or more particular circuit elements of the plurality.

In the present example, semiconductive elements 210, 220, 230 are depicted as bipolar junction transistors. However, any type of semiconductive element may be used. For instance, field effect transistors, power transistors, high frequency transistors, or unijunction transistors may be used. Semiconductive elements other than transistors may be used as well. For example, rectifier diodes, Zener diodes, thrystors, or triacs may be used. Any combination of semiconductive elements are also possible. For example, semiconductive element 210 may be a bipolar junction transistor while semiconductive element 220 may be a field effect transistor. In still other examples, a plurality of diodes may be arranged to perform transistor-like functions. Other semiconductive elements and configurations are possible as well.

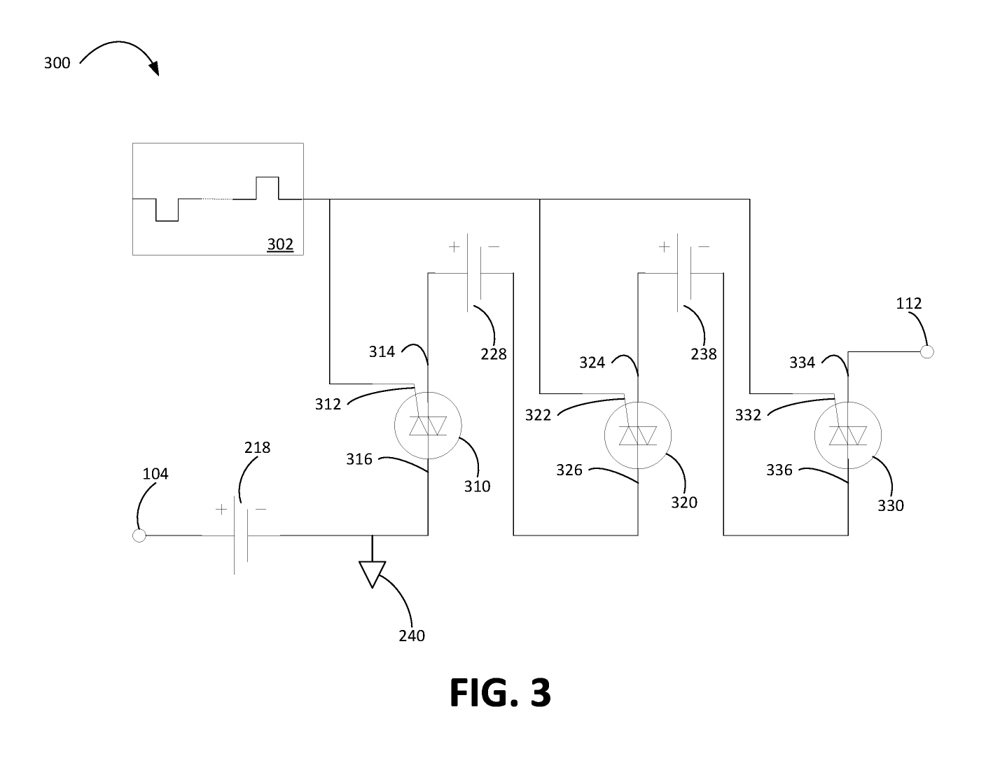

FIG. 3 shows another simplified circuit diagram of a system 300, according to an example embodiment. In the present example, the plurality of circuit elements coupled between terminals 104 and 112 include batteries 218, 228, and 238, and semiconductive elements 310, 320, and 330. Semiconductive element 310 includes input node 312, collector/output node 314, and collector/output node 316, semiconductive element 320 includes input node 322, collector/output node 324, and collector/output node 326, and semiconductive element 330 includes input node 332, collector/output node 334, and collector/output node 336.

The detailed description makes reference to input nodes, collector nodes, and output nodes. It should be readily understood by those having ordinary skill in the art that a collector node refers to a node that draws electric current, an output node refers to a node refers to a node that receives electric current drawn by the collector node, and an input node refers to a node that causes the semiconductive element to conduct electric current from the collector node to the output node. For instance, FIG. 2 shows a plurality of bipolar junction transistors. A collector node may correspond to a collector of a bipolar junction transistor, an output node may correspond to an emitter of the bipolar junction transistor, and an input node may correspond to a base of the bipolar junction transistor. Further, where the semiconductive element is a field effect transistor, a collector node may correspond to a source of the field effect transistor, an output node may correspond to a drain of the field effect transistor, and an input node may correspond to a gate of the field effect transistor.

In the present example, semiconductive elements 310, 320, and 330 are triacs, which may conduct electric current in one of two directions based on control signals received from controller 102. Accordingly, each of collector/output nodes 314, 316, 324, 326, 334, and 336 may serve as a collector node or an output node depending on the direction in which electric current is being conducted. Which nodes correspond to collector nodes and which nodes correspond to output nodes may depend on an operation mode of the system 300.

In a first operation mode of system 300, controller 302 (which may be the same or similar to the controller 102 in FIG. 1) may send first control signals to input nodes 312, 322, and 332. Responsive to receiving the first control signals, input nodes 312, 322, and 332 may cause current to flow from collector node 314 to output node 316, from collector node 324 to output node 326, and from collector node 334 to output node 336 respectively. In a second operation mode of system 300, controller 302 may send second control signals to input nodes 312, 322, and 332. Responsive to receiving the second control signals, input nodes 312, 322, and 332 may cause current to flow from collector node 316 to output node 314, from collector node 326 to output node 324, and from collector node 336 to output node 334 respectively.

In the first operation mode the first control signals may cause semiconductive elements 310, 320, and 330 to drive current from second terminal 112 to first terminal 104. Batteries 218, 228, and 238 may discharge to send electric power to a power sink connected to terminals 104 and 112. In the first operation mode, system 300 may operate in much the same way described above with regard to system 200.

Subsequent to discharging the batteries in the first operation mode, the batteries may be recharged in the second operation mode.

In the second operation mode the second control signals may cause semiconductive elements 310, 320, and 330 to drive current from first terminal 104 to second terminal 112. In the second operation mode, controller 302 may receive an alternating current signal and supply input nodes 312, 322, and 332 with a half-wave pulsed direct current signal based on the receive alternating current signal.

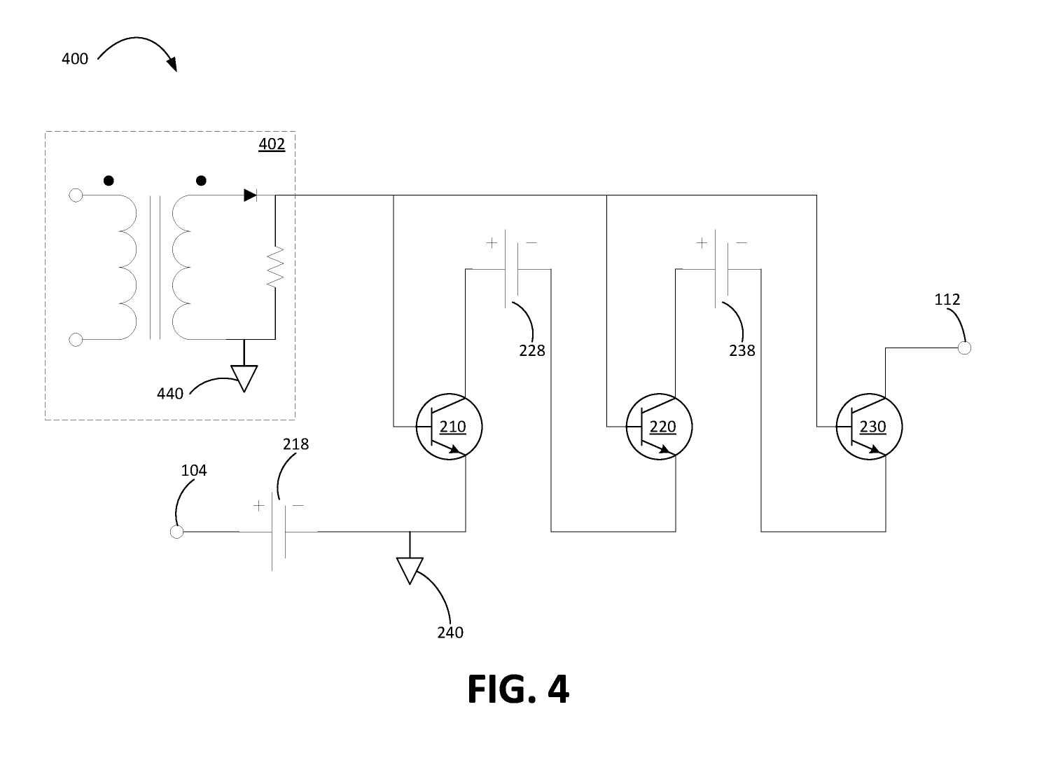

FIG. 4 shows another simplified circuit diagram of a system 400, according to an example embodiment. System 400 includes batteries 218, 228, and 238 and semiconductive elements 210, 220, and 230 coupled between terminals 104 and 112. System 400 also includes ground 240 coupled between battery 218 and semiconductive element 210. Accordingly, system 400 may function in substantially the same way described above with regard to FIG. 2.

The present example additionally includes controller 402 which comprises a pulse transformer having a primary winding and a secondary winding, ground 440 coupled to the secondary winding, and a diode and resistor coupled in parallel with the secondary winding. The secondary winding, batteries 218, 228, and 238, and semiconductive elements 210, 220, and 230 may collectively form a tank circuit. Accordingly, controller 402 may receive an alternating current signal and output a substantially direct current waveform to input nodes associated with semiconductive elements 210, 220, and 230. Controller 302 depicted in FIG. 3 may be configured in the same way as controller 402.

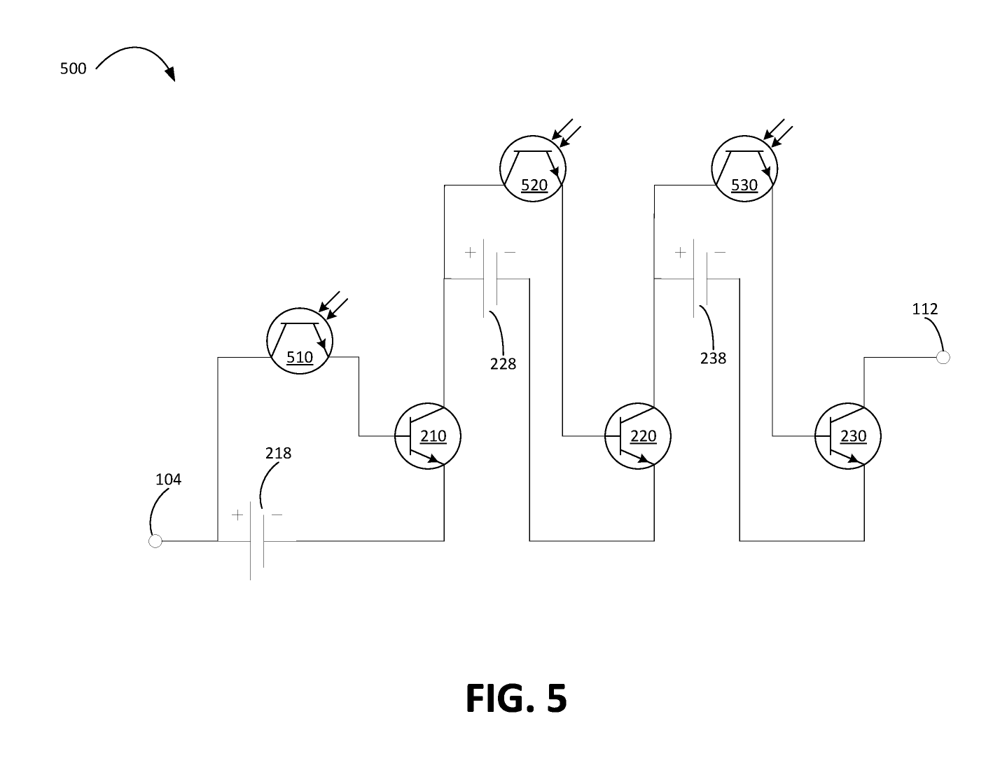

FIG. 5 shows another simplified circuit diagram of a system 500, according to an example embodiment. System 500 includes terminals 104 and 112, batteries 218, 228, and 238, semiconductive elements 210, 220, and 230, and light-sensitive elements 510, 520, and 530 coupled between terminals 104 and 112.

In the present example, input nodes associated with semiconductive elements 210, 220, and 230 may be driven by light-sensitive elements 510, 520, and 530 respectively. Light elements 510, 520, and 530 may receive light signals from a controller, such as controller 102 described above, and may, responsive to receiving the light signals, apply a voltage to the input nodes associated with semiconductive elements 210, 220, and 230. In turn, semiconductive elements 210, 220, and 230 may conduct electric current such that batteries 218, 228, and 238 discharge, as described above with regard to FIG. 2.

In the present example, semiconductive element 210 may correspond to circuit element 106 described above with regard to FIGS. 1 and 2, semiconductive element 220 may correspond to circuit element 108, and semiconductive element 230 may correspond to circuit element 110. Driving semiconductive elements using light-sensitive elements 510, 520, and 530 may allow for none of the semiconductive elements to be referenced to ground. However, in some examples one or more circuit elements may be connected to a ground as described above with regard to FIG. 2.

In the present example, light-sensitive element 510 is connected to a positive terminal of battery 218 such that, when light-sensitive element 510 receives the light signals, a voltage associated with the positive terminal of battery 218 is applied to the input node associated with semiconductive element 210. Light-sensitive element 520 is similarly connected to battery 228, and light-sensitive element 530 is similarly connected to battery 238. It should be understood however, that light-sensitive elements 510, 520, and 530 may be connected to other voltage sources than batteries 218, 228, and 238 respectively. For example, in some embodiments, system 500 may include a separate voltage source connected to each of light-sensitive elements 510, 520, and 530.

Though, in the present example, light-sensitive elements 510, 520, and 530 are depicted as optical transistors, any number of light-sensitive elements may be used to apply a voltage to the input nodes. For instance, photodiodes or light-sensitive switches may be used.

Each of the systems described herein, such as those described above with regard to FIGS. 1, 2, 3, and 4 may include gate control circuits used to drive input nodes of the semiconductive elements. For instance, each circuit element may include a gate control circuit. A given gate control circuit may be configured to receive control signals from a controller, such as controller 102, and to control an input node of a semiconductive element based on the received control signals. For instance, in the present example, light-sensitive elements 510, 520, and 530 may be included within gate control circuits associated with light-sensitive elements 510, 520, and 530. In the present example, the gate control circuits may be optocouplers that include optical transistors. However, it should be understood that any transistor driver may be used as a gate control circuit.

In some examples, each gate control circuit may share a single control signal bus coupled to the controller. The gate control circuits may be configured to control input nodes of respective semiconductive elements such that each semiconductive element simultaneously transfers electric current towards a terminal of the system, such as first terminal 104.

In some examples, each gate control circuit may be referenced to a ground. For example, each gate control circuit element may be coupled to ground 240 depicted in FIGS. 2, 3, and 4. However, it should be understood that the gate control circuits may be referenced to a different ground than ground 240, or to no ground at all.

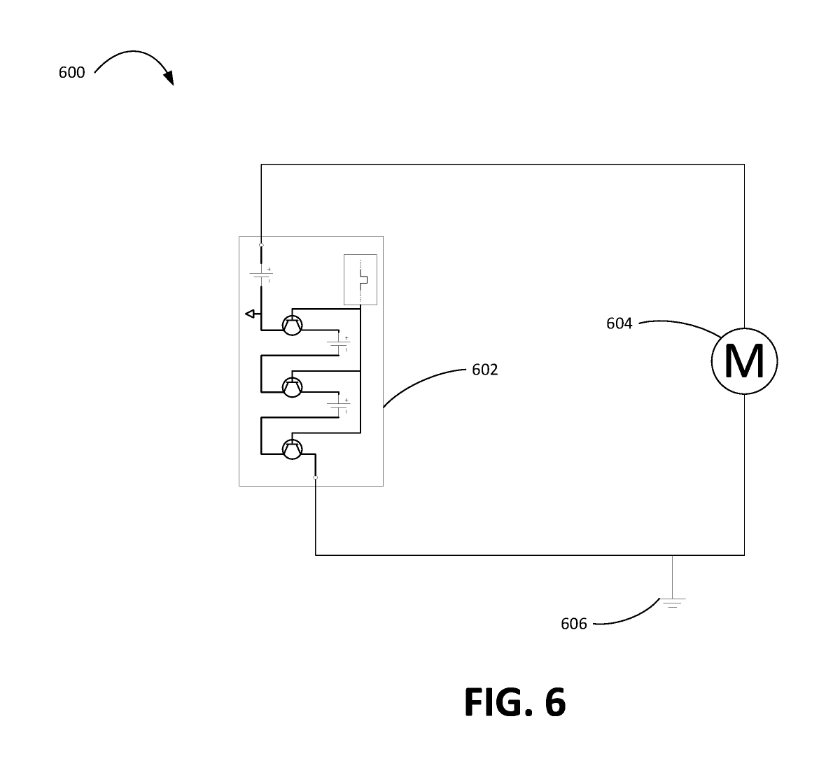

FIG. 6 shows another simplified circuit diagram of a system 600, according to an example embodiment. System 600 includes a battery stack 602, such as those described above with regard to FIGS. 2, 3, and 4, a motor 604, and a ground 606. Motor 604 is connected to a first terminal and a second terminal of battery stack 602. A controller of battery stack 602 may determine control signals that cause the batteries of battery stack 602 to discharge and to thereby transfer electric current to motor 604.

In this way, motor 604 may receive electric power from battery stack 602 via a positive port of motor 604 that connects to the first terminal of battery stack 602 and a negative port of the motor 604 that connects to the second terminal of battery stack 602. The controller of battery stack 602 may send control signals that cause a predefined output to motor 604. For example, the circuit elements of battery stack 602 may control a speed output and a torque output of motor 604 based on the control signals from the controller.

In some embodiments a controller associated with battery stack 602 may include one or more processors and a computer readable medium. The computer readable medium have instructions stored thereon that, when executed by the one or more processors, cause the controller to send control signals to the plurality of circuit elements in the battery stack. For example, the instructions may determine a power output to transfer to a power sink connected to the first terminal and the second terminal. The instructions may further determine control signals to send to the plurality of circuit elements that cause the semiconductive elements conduct sufficient current towards the first terminal to meet or exceed the determined power output.

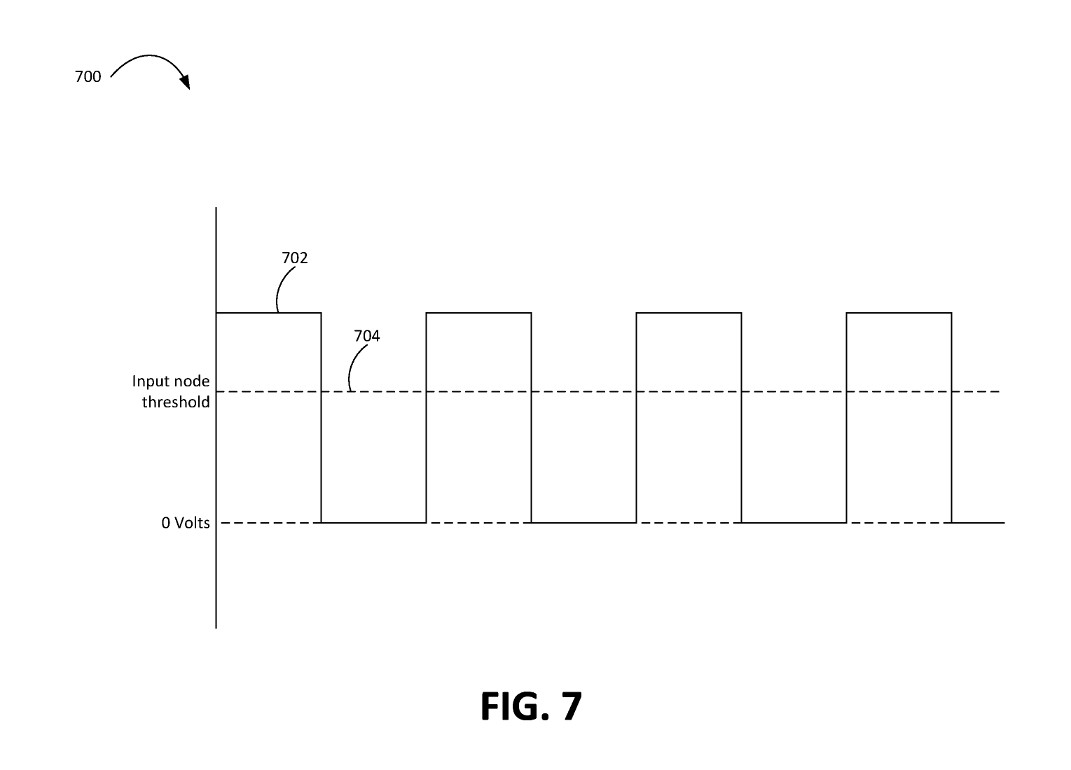

FIG. 7 shows a control signal sent by a controller within a system 700, according to an example embodiment. In the present example, the controller may generate a control signal 702 having a duty cycle of about 50%. The signal may have an on state and an off state. In the on state, control signal 702 meets or exceeds input node threshold voltage 704. Having a higher duty cycle may cause the semiconductive elements to conduct more electric current to a voltage sink, and thus may allow the circuit elements to transfer more power to the power sink.

In some examples the control signals may meet or exceed two or more input node thresholds. For example, where the semiconductive elements comprise triacs, as described above with regard to FIG. 3, the signals may trigger a forward state, a reverse state, and an off state based on whether the control signals meet or exceed the two or more input node thresholds. In other examples, the semiconductive elements may vary the power output proportionally to a voltage of the control signals. Other types of control signals may be used as well.

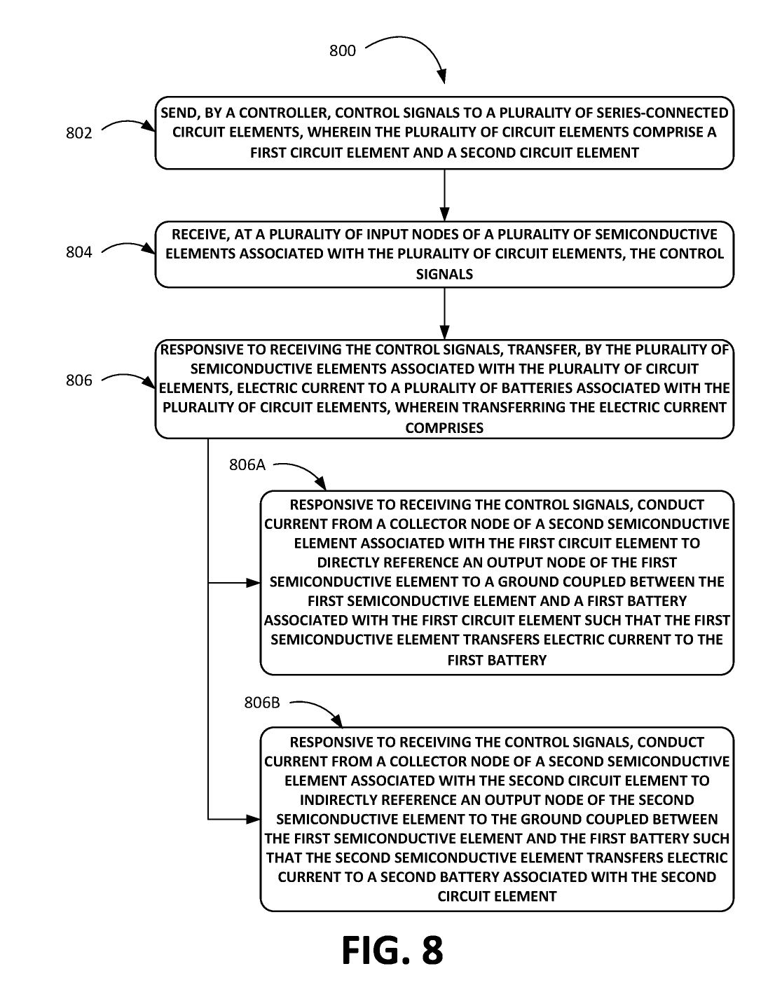

FIG. 8 is a flow chart 800 illustrating an example embodiment. The process illustrated by FIG. 8 may be carried out by any of the systems described above with regard to FIG. 1, 2, 3, or 4.

In addition, for the method shown in FIG. 8 and other processes and methods disclosed herein, the flowchart shows functionality and operation of one possible implementation of present embodiments. In this regard, some blocks may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method and other processes and methods disclosed herein, each block in FIG. 8 may represent circuitry that is wired to perform the specific logical functions in the process.

Block 802 may be performed to send, by a controller, control signals to a plurality of series-connected circuit elements. The plurality of circuit elements may include a first circuit element and a second circuit element.

Block 804 may be performed to receive, at a plurality of input nodes of a plurality of semiconductive elements associated with the plurality of circuit elements, the control signals.

Block 806 may be performed to, responsive to receiving the control signals, transfer, by the plurality of semiconductive elements associated with the plurality of circuit elements, electric current to a plurality of batteries associated with the plurality of circuit elements. Transferring the electric current may include the steps of blocks 806A and 806B.

Block 806A may be performed to, responsive to receiving the control signals, conduct current from a collector node of a first semiconductive element associated with the first circuit element to directly reference an output node of the first semiconductive element to a ground coupled between the first semiconductive element and a first battery associated with the first circuit element such that the first semiconductive element transfers electric current to the first battery.

Some examples may further involve transferring the electric current to the plurality of batteries associated with the plurality of circuit elements contemporaneously by each semiconductive element of the plurality of circuit elements.

Some examples may further involve transferring electric current from the plurality of batteries associated with the plurality of circuit elements to a power sink, wherein transferring the electric current comprises discharging each battery of the plurality of circuit elements.

Some examples may further involve discharging the batteries such that the voltage of each battery of the plurality of circuit elements is reduced by an amount within 0.1 Volts of each other.

Some examples may further involve subsequent to discharging the circuit elements, charging the circuit elements via a power source. In some examples where each semiconductive element comprises a transistor, charging the circuit elements may involve receiving a direct current signal by the controller and providing the control signals to the input nodes associated with the plurality of circuit elements based on the received direct current signal. In other examples where the semiconductive element includes a triac, charging the circuit elements may involve receiving an alternating current signal by the controller and providing the control signals to the input nodes associated with the plurality of circuit elements based on the received alternating current signal.

The examples of FIG. 8 may be simplified by the removal of any one or more of the features shown therein. Further, these embodiments may be combined with features, aspects, and/or implementations of any of the previous figures or otherwise described herein.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrently or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a controller;
a first terminal;
a second terminal;
a plurality of circuit elements connected in series between the first terminal and the second terminal, wherein each circuit element of the plurality of circuit elements comprises:
a semiconductive element having an input node, a collector node, and an output node, wherein the input node is configured to receive control signals from the controller and, responsive to receiving the control signals, conduct electric current from the collector node to the output node,
a battery, having a negative terminal and a positive terminal, wherein the negative terminal is connected to the output node of the semiconductive element,
a first node connected to the positive terminal of the battery, and
a second node coupled to the collector node of the semiconductive element,
wherein at least one of the first node or the second node is coupled to another circuit element of the plurality of circuit elements; and
a ground node exclusively coupled to a respective output node of one semiconductive element associated with a particular circuit element of the plurality of circuit elements.

2. The system of claim 1, wherein the first node of the particular circuit element of the plurality of circuit elements is coupled to the first terminal.

3. The system of claim 1, wherein the second node of the particular circuit element of the plurality of circuit elements is coupled to the second terminal.

4. The system of claim 1, wherein the first node of a first circuit element of the plurality of circuit elements is coupled to the first terminal, wherein the second node of a second circuit element of the plurality of circuit elements is coupled to the second terminal, and wherein the particular circuit element of the plurality of circuit element is coupled between the first circuit element and the second circuit element.

5. The system of claim 1, wherein each circuit element further comprises a gate control circuit and wherein each gate control circuit is configured to receive control signals from the controller and to control a respective input node of a respective semiconductive element based on the received control signals.

6. The system of claim 5, wherein each gate control circuit of the plurality of circuit elements shares a single control signal bus coupled to the controller and wherein, responsive to receiving the control signals, each gate control circuit is configured to control the respective input node of the respective semiconductive element such that each semiconductive element simultaneously transfers electric current towards the first terminal.

7. The system of claim 1, further comprising a motor configured to receive electric power by way of the plurality of circuit elements, wherein a negative port of the motor connects to the second terminal and a positive port of the motor connects to the first terminal, and wherein the plurality of circuit elements are configured to control a speed output and a torque output of the motor based on the control signals of the controller.

8. The system of claim 1, wherein the controller comprises a pulse transformer having a primary winding and a secondary winding, wherein the primary winding is configured to receive an alternating current drive signal and the secondary winding is configured to output a half-wave pulsed direct current signal to the semiconductive elements associated with the plurality of circuit elements.

9. A method comprising:
sending, by a controller, control signals to a plurality of series-connected circuit elements, wherein the plurality of circuit elements comprise a first circuit element and a second circuit element;
receiving, at a plurality of input nodes of a plurality of semiconductive elements associated with the plurality of circuit elements, the control signals; and
responsive to receiving the control signals, transferring, by the plurality of semiconductive elements associated with the plurality of circuit elements, electric current to a plurality of batteries associated with the plurality of circuit elements; wherein transferring the electric current comprises:
responsive to receiving the control signals, conducting current from a collector node of a first semiconductive element associated with the first circuit element to directly reference an output node of the first semiconductive element to a ground coupled between the first semiconductive element and a first battery associated with the first circuit element such that the first semiconductive element transfers electric current to the first battery; and
responsive to receiving the control signals, conducting current from a collector node of a second semiconductive element associated with the second circuit element to indirectly reference an output node of the second semiconductive element to the ground coupled between the first semiconductive element and the first battery such that the second semiconductive element transfers electric current to a second battery associated with the second circuit element.

10. The method of claim 9, wherein transferring the electric current to the plurality of batteries associated with the plurality of circuit elements is performed contemporaneously by each semiconductive element of the plurality of circuit elements.

11. The method of claim 9, further comprising transferring electric current from the plurality of batteries associated with the plurality of circuit elements to a power sink, wherein transferring the electric current comprises discharging each battery of the plurality of circuit elements.

12. The method of claim 11, wherein discharging the batteries comprises reducing a voltage of each battery of the plurality of circuit elements by an amount within 0.1 Volts of each other.

13. The method of claim 11, further comprising:
subsequent to discharging the circuit elements, charging the circuit elements via a power source.

14. The method of claim 13, wherein each semiconductive element comprises a transistor, and wherein charging the circuit elements comprises receiving a direct current signal by the controller and providing the control signals to the input nodes associated with the plurality of circuit elements based on the received direct current signal.

15. The method of claim 13, wherein each semiconductive element comprises a triac, and wherein charging the circuit elements comprises receiving an alternating current signal by the controller and providing the control signals to the input nodes associated with the plurality of circuit elements based on the received alternating current signal.

16. A system comprising:
a controller;
a first terminal;
a second terminal;
a plurality of circuit elements connected in series between the first terminal and the second terminal, wherein the plurality of circuit elements comprise:
a first circuit element comprising a first battery and a first semiconductive element, wherein the first semiconductive element comprises an input node, a collector node, and an output node, wherein the input node is configured to receive control signals from the controller and, responsive to receiving the control signals, conduct electric current from the collector node to the output node, wherein the output node shares a bus with a negative end of the first battery, and wherein a positive end of the first battery is coupled to the first terminal, and
a second circuit element comprising a second battery and a second semiconductive element, wherein the second semiconductive element comprises an input node, a collector node, and an output node, wherein the input node is configured to receive control signals from the controller and, responsive to receiving the control signals, conduct electric current from the collector node to the output node, wherein the output node shares a bus with a negative end of the second battery, and wherein the collector node is coupled to a positive end of a battery associated with a third circuit element of the plurality of circuit elements, and wherein a positive end of the second battery is coupled to the collector node associated with the first circuit element; and
a single ground exclusively coupled between an output node of a semiconductive element associated with a particular circuit element of the plurality of circuit elements and a negative end of a battery associated with the particular circuit element.

17. The system of claim 16, wherein each circuit element further comprises a gate control circuit and wherein each gate control circuit is configured to receive control signals from the controller and to control a respective input node of a respective semiconductive element based on the received control signals, and wherein each gate control circuit is referenced to the single ground.

18. The system of claim 16, wherein the single ground is exclusively coupled between the output node of the first semiconductive element and the negative end of the first battery.

19. The system of claim 16, wherein the single ground is exclusively coupled between the output node of the second semiconductive element and the negative end of the second battery.

20. The system of claim 16, wherein the plurality of circuit elements comprise at least ten circuit elements, and wherein the first circuit element is the only circuit element of the plurality coupled to the single ground.
